(19) United States
(12) Patent Application Publication
(10) Pub. No.: US 2006/0005459 A1
(43) Pub. Date: Jan. 12, 2006

(54) Frame for baitfish lure

(76) Inventor: S. D. Lehman, Carlsbad, CA (US)

Correspondence Address: John R. Ross, III;Ross Patent Law Office, P.O. Box 2138, Del Mar, CA, 92014, US

(21) Appl. No.: 10/889,809

(22) Filed: Jul. 12, 2004

(51) Int. Cl. A01K 85/00; A01K 85/18

(52) U.S. Cl. 43/42.15; 43/42.36

(57) ABSTRACT

A linked baitfish lure frame. A head section link is linked to a tail section link. The head section link includes at a line connection arc and a tail section link arc. The tail section link includes at least one hook arc and a head section link arc. In the preferred embodiment the head of a dead baitfish is sewn onto the head section link and the tail of the dead baitfish is sewn onto the tail section link. Also, preferably the head section link includes a hook arc.

The present invention relates to fishing lures, and in particular, to baitfish fishing lure frames.

### BACKGROUND OF THE INVENTION

Recreational deep sea fishing is an extremely popular sport. Fishermen spend large amounts of money and time trying to perfect their favorite pastime. With a large variety of lures and bait preferences from which to choose, a key part of the fishermen's strategy is deciding what bait or lure is the best to use to catch the fish.

The best choice for lure and bait depends on a variety of factors, such as time of year, the location, the type of fish that is being pursued, the skill of the fisherman, and the fisherman's personal preferences. Fishermen will often choose a lure that they feel closely resembles the baitfish that their quarry prefers. For example, sailfish is a popular big game fish caught off the coast of Mexico that typically feeds on ballyhoo. To catch a sailfish, it is common for fishermen to troll a lure that resembles ballyhoo. However, while a lure can be made to look similar to an actual baitfish, it is still an artificial device that sometimes does not fool the target fish.

For this reason some fishermen prefer to troll an actual baitfish. These fishermen will often press a hook through the head or back of a baitfish and troll the baitfish that is either dead when he is hooked or soon dies. This method, however, does not work well because dead baitfish being trolled through the water usually do not accurately resemble a live baitfish swimming through the water, so the target fish is not fooled and will ignore the bait.

Extremely strong chains are made by linking link sections of metal wire and welding the ends of each section together to form the linked chain.

What is needed is a device to make baitfish look more natural.

### SUMMARY OF THE INVENTION

The present invention provides a linked baitfish lure frame. A head section link is linked to a tail section link. The head section link includes at a line connection arc and a tail section link arc. The tail section link includes at least one hook arc and a head section link arc. In the preferred embodiment the head of a dead baitfish is sewn onto the head section link and the tail of the dead baitfish is sewn onto the tail section link. Also, preferably the head section link includes a hook arc.

### BRIEF DESCRIPTION OF THE DRAWINGS

FIG. 1 shows a perspective view of a preferred embodiment of the present invention.

FIG. 2A shows a side view of a preferred embodiment of the present invention.

FIG. 2B shows a top view of a preferred embodiment of the present invention.

FIG. 3A shows a side view of a dead baitfish.

FIG. 3B shows a bottom view of the dead baitfish of FIG. 3A.

FIG. 3C shows a top view of the dead baitfish of FIG. 3A.

FIG. 4 shows the dead baitfish of FIG. 3A cut in two.

FIGS. 5 and 6 show the dead baitfish of FIG. 3A attached to a preferred linked baitfish frame.

FIG. 7 shows hooks, line and the dead baitfish of FIG. 3A attached to a preferred embodiment of the present invention.

FIGS. 8-10 illustrate to utilization of a preferred embodiment of the present invention.

FIG. 11 shows a sinker weight attached to a preferred embodiment of the present invention.

FIG. 12 shows another preferred embodiment of the present invention.

FIG. 13 shows another preferred embodiment of the present invention.

FIG. 14 shows another preferred embodiment of the present invention.

FIG. 15 shows another preferred embodiment of the present invention.

FIG. 16 shows another preferred embodiment of the present invention.

### DETAILED DESCRIPTION OF THE PREFERRED EMBODIMENTS

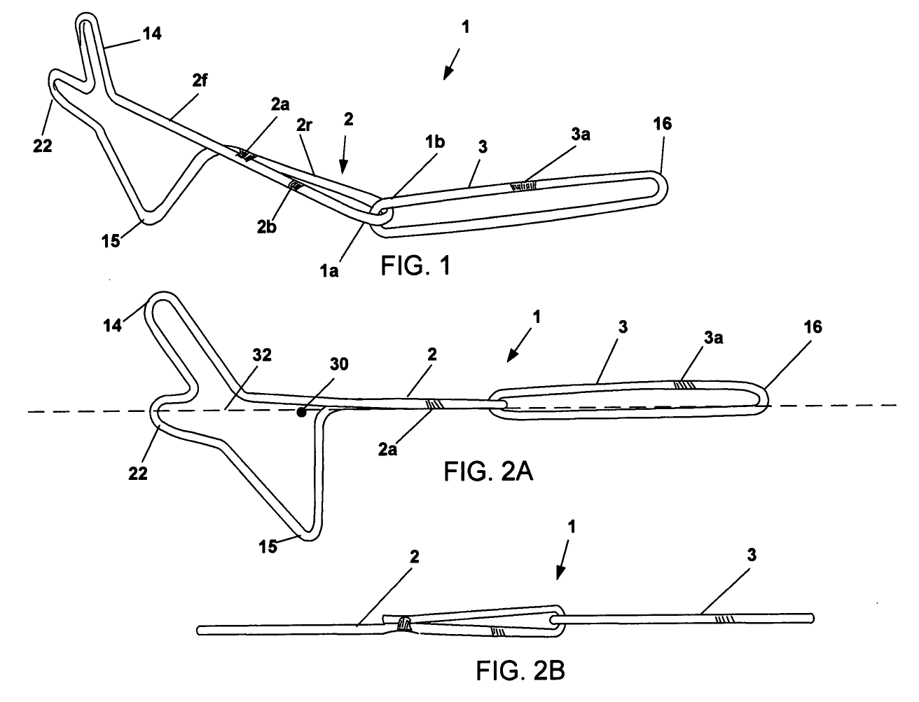

A detailed description of preferred embodiments of the present invention can be described by reference to FIGS. 1-16.

FIG. 1 shows a perspective view of steel linked frame 1 having head section link 2 and tail section link 3. FIGS. 2A and 2B show a side view and top view, respectively, of linked frame 1. In a preferred embodiment, linked frame 1 is fabricated from ⅛ diameter steel wire. For improved strength, head section link 2 and tail section link 3 are both closed links. To form the closed links, the ⅛ diameter steel wire is preferably bent into the shapes shown in FIGS. 1-2B and the ends of the wire are welded together at welds 2b and 3a. Linked frame 1 includes arcs 14, 15, 16 and 22 for attaching a line, hooks and (if desired) a weight. Linked frame 1 also includes arc 1a in the head section link to make a “U” loop connection to arc 1b in the tail section link. Head section link 1 has a length of approximately 5 inches and tail section link 3 has a length of approximately 4 inches. Head section link 2 is preferably also welded at weld 2a for additional strength.

Link Connection

Head section link 2 and tail section link 3 are preferably linked together at a link-connection as shown as shown in FIG. 1. This arrangement permits tail section link 3 to move laterally side-to-side in a manner that resembles live fish movement (FIGS. 9-10). The link-connection is preferable because it is very resistant to corrosion and fouling. Also, as stated above the strength of the connection is improved because head section link 2 and tail section link 3 are both closed links. Maximizing the strength of the connection is important, especially if targeting large fish. For example, a sailfish can easily weigh 130 pounds. When caught on a hook a sailfish will put up a fierce fight.

The preferred embodiments shown in FIGS. 1-15 are designed so that the dead fish with the link frame inside will appear to “swim” like a fish when pulled through the water at typical swim speeds for baitfish. This means that the fish must move generally horizontally through the water, with the head in front and the tail following. The lure should not spin and the fish should remain “upright” (that is, it top fins should remain on top). Its tail should weave horizontally. Features are incorporated in the design shown in the figures to accomplish these objectives.

To make sure that the lure remains upright as it is pulled through the water, the lure will define a center of gravity designated as 30 in FIG. 2A and swimming axis designated as dotted line 32 in FIG. 2A. Line attachment arc 14 is preferably located so that a straight line between the middle of arc 14 and the center of gravity 30 makes an angle with the forward direction of swimming axis 32 of substantially less than 90 degrees, and substantially greater than 30 degrees, preferably about 45 degrees. As noted above, weights can be added to change the location of the center of gravity. The line attachment arc defines the top of the lure and assures that the lure will remain upright and not spin when pulled through the water at normal speeds with gravity applying a downward force and the line tension applying an upward and forward force.

In a preferred embodiment, the wire making the head section link of the link frame is formed to provide a vertically oriented front portion 2f and a horizontally oriented rear portion 2r and then welded at weld 2a for extra strength (FIG. 1). Horizontally oriented rear portion 2r allows for both tail section link 3 and head section link 2 to be aligned vertically. Preferably, tail section link 3 is vertical because fish tails are oriented in the vertical plane. Head section link 2 is preferably vertical because it is desirable to attach the line above the lure's center of gravity so that the top of the lure stays on top and the fish doesn't spin.

Attaching the Baitfish to the Linked Frame

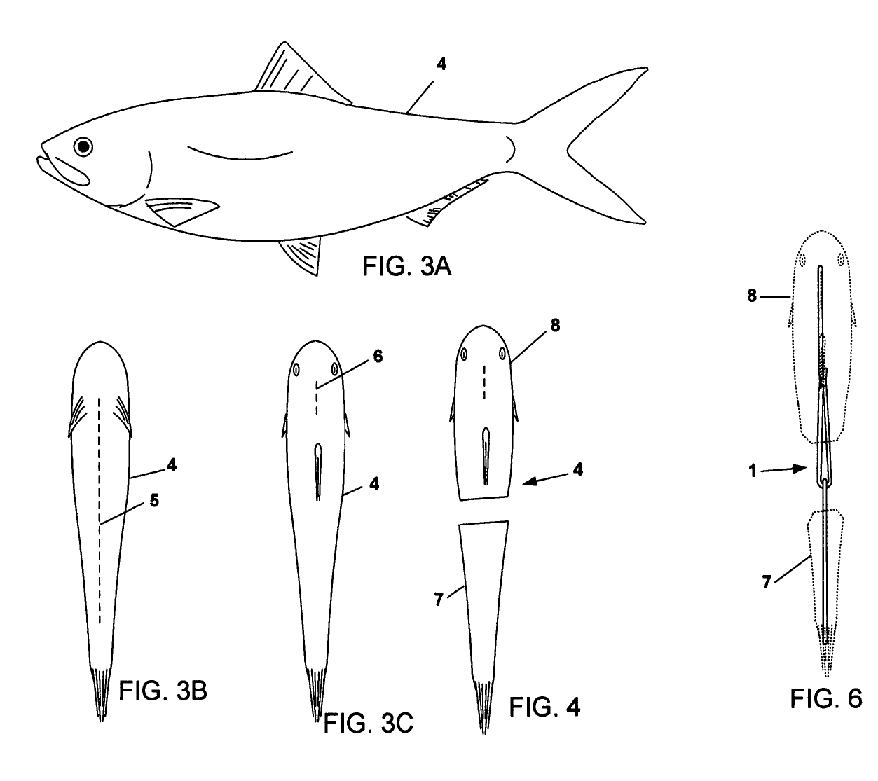

FIGS. 3A-3C show a side view, bottom view and top view of dead baitfish 4.

In FIG. 3B, baitfish 4 is cut on the underside from the head to the tail as shown at cut 5. The entrails of baitfish 4 are removed and the backbone is cut out.

In FIG. 3C, a second cut 6 is made from the underside through the top of baitfish 4.

In FIG. 4, baitfish 4 is cut separating fish tail section 7 and fish head section 8.

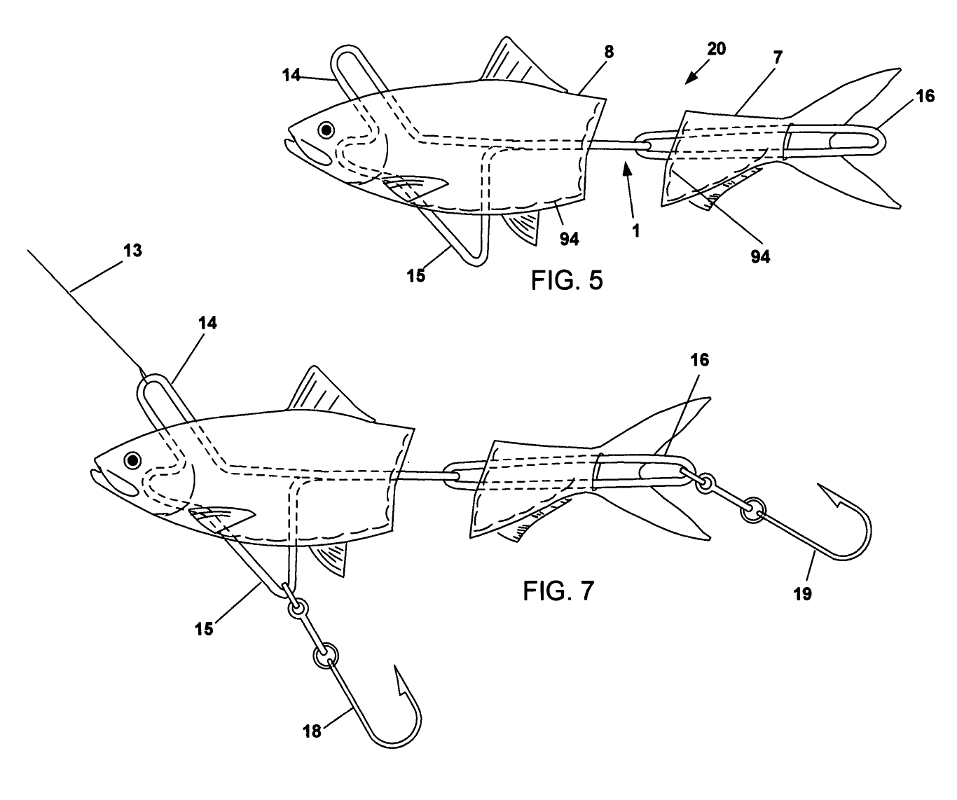

In FIG. 5, fish tail section 7 and fish head section 8 have been attached to linked frame 1 to form linked baitfish lure 20. Frame arcs 14, 15 and 16 are exposed. In order to further secure fish tail section 7 and fish head section 8 to linked frame 1, both are sewn (as to close cut 5 and to connect the fish to both sections of the frame. FIG. 5 shows a side view of fish tail section 7 and fish head section 8 attached to frame 1 with thread 94. FIG. 6 shows a top view of fish tail section 7 and fish head section 8 attached to linked frame 1. Fish tail section 7 and fish head section 8 are in dotted line.

Attaching Hooks and Line to the Linked Frame

In FIG. 7 line 13 has been tied to arc 13, hook 18 has been attached to arc 15 and hook 19 has been attached to arc 16.

Utilization of the Linked Frame

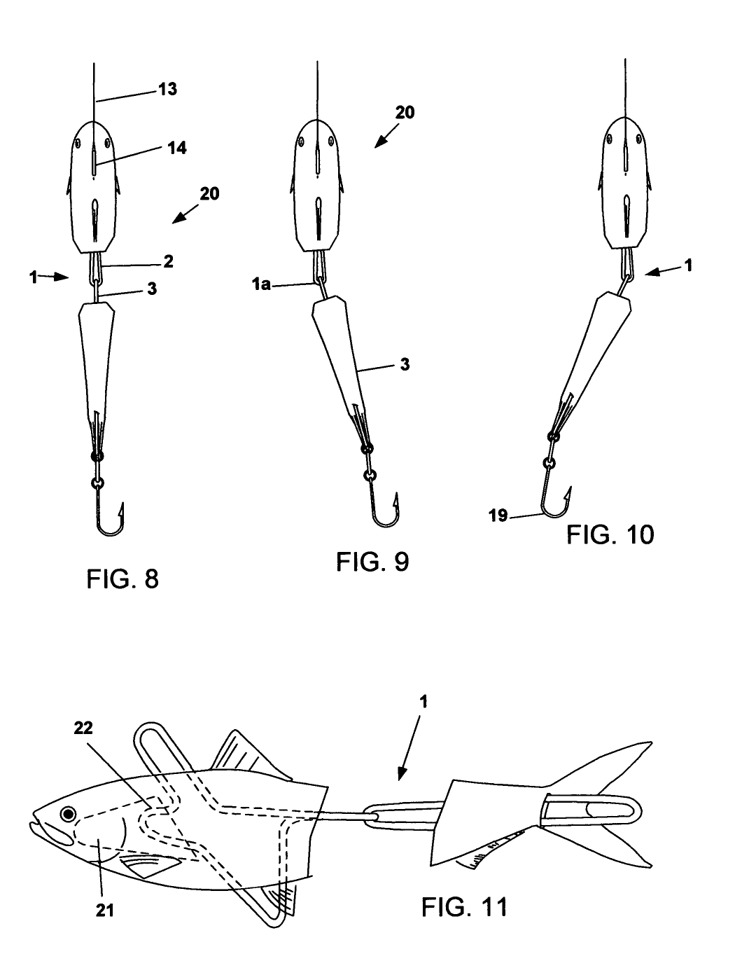

FIG. 8 shows a top view of line 13 pulling linked baitfish lure 20 through water.

In FIG. 9 forces acting on linked baitfish lure 20 as a result of line 13 pulling linked baitfish lure 20 through the water have caused fish tail section 7 to move rightward in a manner that resembles that of a fish swimming through the water.

Likewise, in FIG. 10 forces acting on linked baitfish lure 20 as a result of line 13 pulling linked baitfish lure 20 through the water have caused fish tail section 7 to move leftward in a manner that resembles that of a fish swimming through the water.

The fisherman hopes that the left to right motion illustrated in FIGS. 9-10 is attractive to a large deep sea game fish. It is likely that a fish attracted to linked baitfish lure 20 will be caught by either hook 19 or 18 (FIG. 7) if the fish attempts to bite the lure.

It should be noted that in the preferred embodiment, sewing head section 8 and tail section 7 to frame 1 pinches the part of the fish that is under thread 94 (FIG. 5). This causes tail section 7 to assume a more streamlined shape as lure 20 is trolled through the water. The pinched areas are shows as areas 84 in FIG. 9.

Adding Sinker Weight to Sink Lure

In FIG. 11, 12-ounce lead sinker weight 21 has been attached to linked frame 1 at arc 22. The purpose of the sinker weight is to sink the lure as it is being trolled through the sea in order to more accurately mimic the swimming habits of baitfish that swim beneath the surface of the sea.

Artificial Lure Embodiment

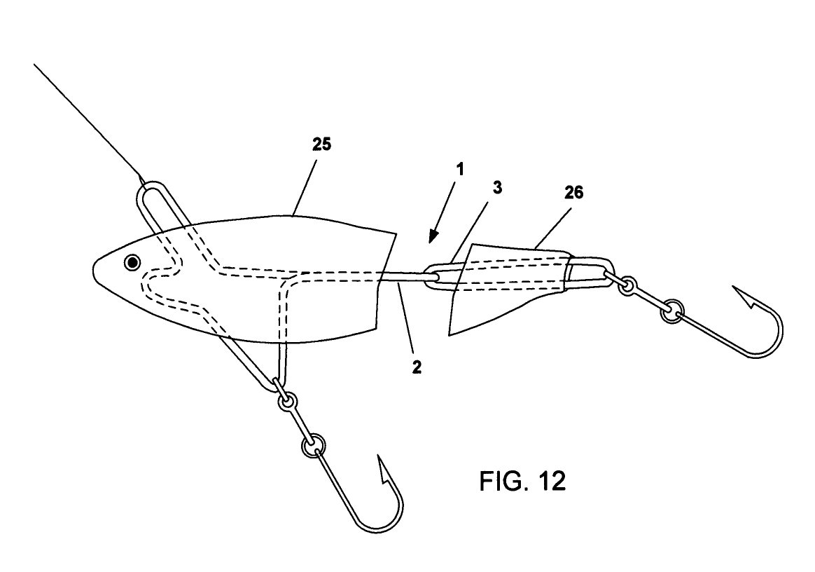

FIG. 12 shows another preferred embodiment of the present invention in which an artificial fish has been attached to linked frame 1. Hard plastic fish head 25 has been molded around head section link 2 and hard plastic fish tail 26 has been molded around tail section link 3. The embodiment shown in FIG. 12 is for fishermen who prefer artificial lures and fishermen who do not have access to baitfish.

Size

Preferred embodiments of the present invention can be made in virtually any size. For example, a link frame used to catch a sailfish is designed for a 2 pound bait fish and is about one foot long. At the other end of the scale is a link frame useful for fishing mountain streams for trout. These units are made to fit inside one inch minnows using very thin steel wire having a diameter of approximately 1/32 of an inch.

Alternative Joints

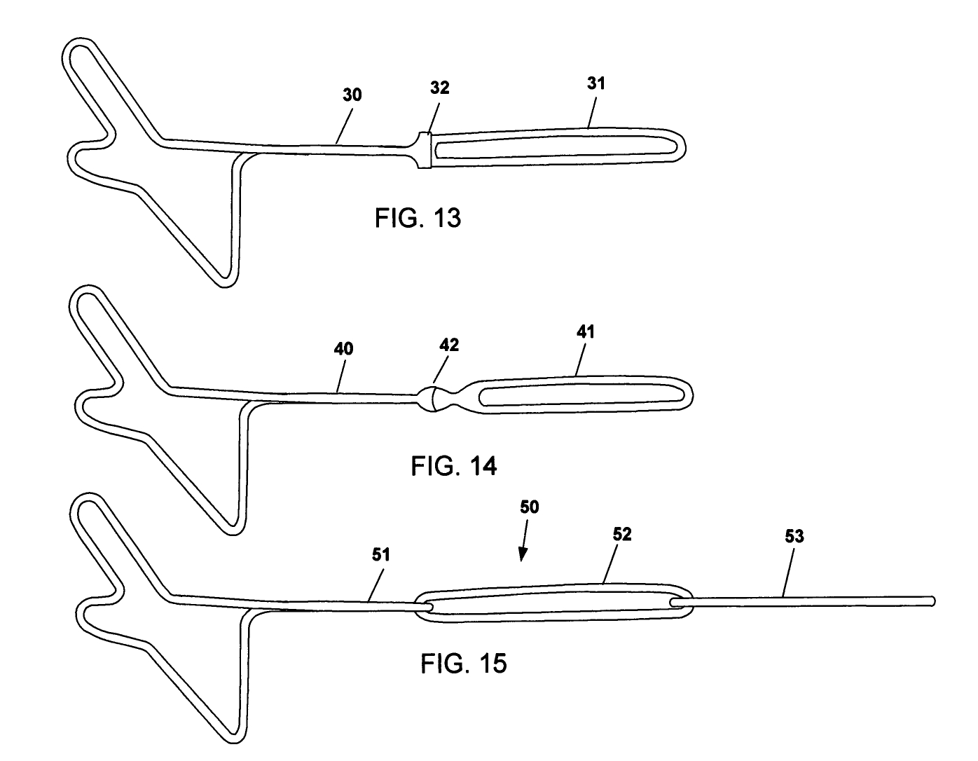

Although the above preferred embodiments state that head section link 2 and tail section link 3 are linked together as shown at joint 1a (FIG. 1), it is possible to connect the head and tail section link utilizing other methods. For example, in FIG. 13, head section link 30 and tail section link 31 are joined together by the utilization of hinge 32.

Alternatively, in FIG. 14, head section link 40 and tail section link 41 are joined together by the utilization of swivel joint 42.

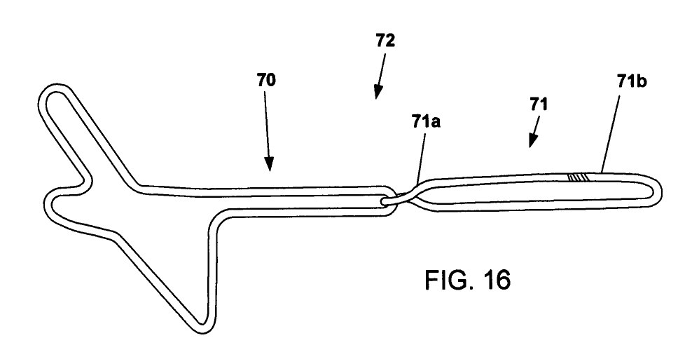

Although the above-preferred embodiments have been described with specificity, persons skilled in this art will recognize that many changes to the specific embodiments disclosed above could be made without departing from the spirit of the invention. For example, although fish head 25 was described as being molded from hard plastic, fish head 25 could be molded and fabricated from a variety of materials including fiberglass and a variety of composite materials, as well as other plastic-like materials. Also, although the above preferred embodiments showed a dead baitfish attached to linked frame 1, other dead bait can be attached to the frame. For example, a dead frog or a dead eel or snake can be attached in a similar fashion. Also, although FIG. 1 shows head section link 2 and tail section link 3, it would be possible to form linked frame 1 with more closed link sections. For example, to more closely resemble the motion of an eel or snake, it would be appropriate to form a linked frame so that it has at least 3 or 4 closed link sections. As shown in FIG. 15, linked frame 50 has head section link 51, middle section link 52, and tail section link 53. Also, FIG. 16, shows that it is possible to form tail section 71 so that it has horizontal front portion 71a and vertical rear portion 71b. By linking head section link 70 with horizontal front portion 71a, both head section link 70 and tail section 71 can be aligned vertically. Therefore, the attached claims and their legal equivalents should determine the scope of the invention.

What is claimed is:

1. A linked baitfish lure frame, comprising:
A. a head section link, comprising:
1) a line connection arc, and
2) a tail section link arc, and
B. a tail section link, comprising:
1) at least one hook arc, and
2) a head section link arc,
wherein said tail section link is linked to said head section link.

2. The linked baitfish lure frame as in claim 1 wherein said head section link further comprises a weight arc for attaching a sinker weight.

3. The linked baitfish lure as in claim 1 wherein said head section link and said tail section link are both closed links.

4. The linked baitfish lure frame as in claim 1 further comprising a middle section link defining a front link arc and a rear link arc said middle section link being linked between said head section link and said tail section link.

5. The linked baitfish lure frame as in claim 1, further comprising:
A. a head of a dead baitfish connected to said head section link, and
B. a tail of said dead baitfish connected to said tail section link.

6. The linked baitfish lure frame as in claim 5 wherein said head is sewn onto said head section link and wherein said tail is sewn onto said tail section link.

7. The linked baitfish lure as in claim 1, wherein said head section link further comprises at least one hook arc.

8. The linked baitfish lure frame as in claim 1, further comprising
A. an artificial fish head connected to said head section link, and
B. an artificial fish tail connected to said tail section link.

9. A linked baitfish lure frame, comprising:
A. a head section link, comprising:
1) a line connection arc, and
2) a tail section link arc, and
B. a tail section link, comprising:
1) at least one hook arc, and
2) a head section link arc,
C. a hinge for joining said head section link to said tail section link, and
D. a dead baitfish attached to said baitfish lure frame.

10. A linked baitfish lure frame, comprising:
A. a head section link, comprising:
1) a line connection arc, and
2) a tail section link arc, and
B. a tail section link, comprising:
1) at least one hook arc, and
2) a head section link arc,
C. a swivel joint for joining said head section link to said tail section link, and
D. a dead baitfish attached to said baitfish lure frame.

11. A linked baitfish lure frame, comprising:
A. a head section link means, comprising:
1) a line connection arc, and
2) a tail section link arc, and
B. a tail section link means, comprising:
1) at least one hook arc, and
2) a head section link arc,
wherein said tail section link is linked to said head section link.

12. The linked baitfish lure frame as in claim 11 wherein said head section link means further comprises a weight arc means for attaching a sinker weight.

13. The linked baitfish lure as in claim 11 wherein said head section link means and said tail section link means are both closed links.

14. The linked baitfish lure frame as in claim 11 further comprising a middle section link means defining a front link arc and a rear link arc said middle section link means being linked between said head section link means and said tail section link means.

15. The linked baitfish lure frame as in claim 11, further comprising:
A. a head of a dead baitfish connected to said head section link means, and
B. a tail of said dead baitfish connected to said tail section link means.

16. The linked baitfish lure frame as in claim 15 wherein said head is sewn onto said head section link means and wherein said tail is sewn onto said tail section link means.

17. The linked baitfish lure as in claim 11, wherein said head section link means further comprises at least one hook arc.

18. The linked baitfish lure frame as in claim 11, further comprising
A. an artificial fish head means connected to said head section link means, and
B. an artificial fish tail means connected to said tail section link means.

19. A linked baitfish lure frame, comprising:
A. a head section link means, comprising:
1) a line connection arc, and
2) a tail section link arc, and
B. a tail section link means, comprising:
1) at least one hook arc, and
2) a head section link arc,
C. a hinge means for joining said head section link means to said tail section link means, and
D. a dead baitfish attached to said baitfish lure frame.

20. A linked baitfish lure frame, comprising:
A. a head section link means, comprising:
1) a line connection arc, and
2) a tail section link arc, and
B. a tail section link means, comprising:
1) at least one hook arc, and
2) a head section link arc,
C. a swivel joint means for joining said head section link means to said tail section link means, and
D. a dead baitfish attached to said baitfish lure frame means.
